(19) United States
(12) Patent Application Publication
(10) Pub. No.: US 2022/0110312 A1
(43) Pub. Date: Apr. 14, 2022

(54) Mouthpiece for an Intraoral Game Caller

(71) Applicants: Thomas Farrell Robinson, Vestavia, AL (US); Farrell Eugene Robinson, Mountain Brook, AL (US)

(72) Inventors: Thomas Farrell Robinson, Vestavia, AL (US); Farrell Eugene Robinson, Mountain Brook, AL (US)

(21) Appl. No.: 17/492,733

(22) Filed: Oct. 4, 2021

Related U.S. Application Data
(60) Provisional application No. 63/089,051, filed on Oct. 8, 2020.

(51) Int. Cl. A01M 31/00

(52) U.S. Cl. CPC A01M 31/004

(57) ABSTRACT

A mouthpiece for an intraoral game caller having teeth holding members that cover and hold tops and sides of the teeth. Side portions extend from the teeth holding members and a roof portion extends from the side portions. The teeth holding members anchor the roof portion against the roof of the mouth so that the roof portion contacts, covers, and seals a portion of the roof of the mouth. A retaining slot in the roof portion provides for reversible insertion and removal of an intraoral game caller. The mouthpiece is made entirely of plastic or rubber, is flexible, and is custom fit for each user so that it can be worn comfortably for a long period of time. The mouthpiece allows a user to move the tongue to produce sound without having to also use the tongue to keep the intraoral game caller adjacent to the roof of the mouth.

### CROSS-REFERENCE TO RELATED APPLICATION

This application claims priority to and the benefit of U.S. Provisional Patent Application No. 63/089,051, filed Oct. 8, 2020, which is incorporated by reference herein in its entirety for all purposes.

### FIELD OF THE INVENTION

The invention described herein relates generally to intraoral game callers for calling turkeys, Elk, and predators wherein the game callers use diaphragm reeds to produce sound. The invention relates, more particularly, to mouthpieces to maintain an intraoral game caller against the roof of the mouth of a user.

### BACKGROUND OF THE INVENTION

Conventional intraoral animal or game callers use air blown past one or more reed members to produce sound. One common assembly involves a flat reed wedged between wood, cork, plastic, or metal with air being blown past that assembly to cause the reed to vibrate and thereby produce sound. The intraoral game caller assembly usually involves essentially U-shaped frames, situated one atop the other and sandwiching therebetween a reed. The intraoral game caller assembly is inserted inside the hunter's mouth and is situated near the upper palate, to facilitate the blowing of air past the diaphragm reed as breath exits the user's mouth. The intraoral game caller assembly may include a crescent shaped flap that contacts the user's palate to partially prevent the misdirection of breath between the palate and intraoral game caller, rather than beneath the intraoral game caller.

In order to use an intraoral game caller, the user seals the intraoral game caller against the roof of the mouth by pressing the tongue up against the intraoral game caller to force the intraoral game caller against the roof of the mouth. However, sealing difficulties arise due to variations in the roof of the mouth among users. In some cases, the roof of the mouth is narrow and high-arched, in other cases it is somewhat flat, and in yet other cases it is in between high-arched and flat. For users wearing a denture plate, there is difficulty in sealing due to the denture plate being hard and rigid, thus not having any flexibility to accommodate sealing. Moreover, if the user has a bump or the like in the roof of the mouth, the user must push harder with the tongue to create a seal. The use of cloth materials or elastomeric materials does not offer a satisfactory solution to the sealing difficulties. Also, the ability of users to slightly bend the caller to better conform the caller to the roof of the mouth also does not offer a satisfactory solution to the problem.

It is well known to employ diaphragms in intraoral game callers which are small enough to be held in a person's mouth for imitating the sounds made by wild game. Some persons have achieved proficiency in utilizing such intraoral game callers which is accomplished usually as the result of many hours of practice. For those persons who desire to use a diaphragm-type intraoral game caller and who would like to achieve some competence without many hours of experimentation, there has remained a need for improvement.

U.S. Pat. No. 4,218,845 discloses a bird-calling device having a rigid base made somewhat in the form of a partial denture plate which is adapted to fit snugly in the roof of a user's mouth. The rigid base has protruding wires or the like so that it may be securely anchored to an upper tooth. The rigid base has a generally U-shaped configuration, with the open portion of the U being toward the front of the user's mouth when it is installed. Within the U-shaped recess is an internally facing narrow groove. A removable diaphragm assembly is sized to provide an air-tight fit within the central recess, with the diaphragm being positioned so that it is exposed to selective contact by the user's tongue. When the user expels air past the diaphragm, an imitation bird sound may be produced; and the sound may be varied by changing the position of the user's tongue, i.e., changing the contact between the diaphragm and the tongue. This device has not been satisfactory because the rigid base is not held in place satisfactorily on the roof of the mouth with a wire anchored to an upper tooth. There remains a need for improvement. Accordingly, it is an object of this invention to provide an intraoral game caller which can produce a high degree of realistic game calls without the need for tedious hours of training, practice, and experimentation.

### SUMMARY OF THE INVENTION

This invention provides a mouthpiece for intraoral game callers. The mouthpiece has one or more teeth holding members constructed to cover and hold one or more teeth of a user, side portions extending from the teeth holding members, and a roof portion extending from the side portions. A retaining slot is formed in the roof portion for reversible insertion and removal of an intraoral game caller. The mouthpiece is made entirely of plastic or rubber and is flexible.

The teeth holding members are constructed to cover and hold tops and sides of the one or more teeth. The mouthpiece is a custom fit mouthpiece constructed to fit all the contours of the upper mouth of an individual user. The one or more teeth holding members anchor the roof portion against the roof of the mouth of the user so that the roof portion contacts, covers, and seals a portion of the roof of the user's mouth. The user's expired air is directed entirely across the intraoral game caller. When the user expels air past the intraoral game caller, an imitation game sound is produced, and the sound may be varied by changing the position of the user's tongue with respect to the intraoral game caller.

The retaining slot is constructed to allow insertion and removal of an intraoral game caller into or out of the retaining slot during use when the mouthpiece and retaining slot are positioned in the upper mouth of the user. The roof portion and retaining slot may be restricted to the front, middle, or rear area of the roof of the upper mouth of the user.

An advantage of this invention is a mouthpiece for an intraoral game caller, wherein the mouthpiece is customized to fit each user and is comfortable to wear for long periods of time because it is made of plastic or rubber and is flexible.

Another advantage is an open retaining slot wherein a user can exchange intraoral game calls quickly without have to remove the mouthpiece from the mouth.

Another advantage is a mouthpiece for an intraoral game caller that anchors the game caller to the roof of the mouth so that a user is free to move the tongue to produce sound without having to use the tongue to also keep the intraoral game caller adjacent to the roof of the mouth.

Another advantage is a mouthpiece that is simple to manufacture using common and readily available inexpensive dental materials.

### BRIEF DESCRIPTION OF THE DRAWINGS

FIG. 1 is a front, perspective view of a dental upper teeth and mouth molding tray for producing an upper teeth and mouth mold of a user.

FIG. 2 is a rear perspective view of an upper teeth and upper mouth mold of a user.

FIG. 3 is a top view of a mouthpiece for intraoral game callers.

FIG. 4 is a bottom view of the mouthpiece for intraoral game callers.

FIG. 5 is a top view of an intraoral game caller.

FIG. 6 is a front view of the intraoral game caller.

FIG. 7 is a bottom view of the mouthpiece with an intraoral game caller inserted into a retaining slot of the mouthpiece.

FIG. 8 is a front perspective view of the mouthpiece with an intraoral game caller inserted into the retaining slot of the mouthpiece.

FIG. 9 is a rear perspective view of the mouthpiece with an intraoral game caller inserted into the retaining slot of the mouthpiece and with the mouthpiece positioned on the upper teeth and upper mouth of the upper mouth mold of the user.

### DESCRIPTION OF THE INVENTION

While the following description details the preferred embodiments of the present invention, it is to be understood that the invention is not limited in its application to the details of arrangement of the parts illustrated in the accompanying figures, since the invention is capable of other embodiments and of being practiced in various ways.

The invention described herein relates generally to intraoral game caller devices for calling turkeys, Elk, and predators using diaphragm reeds to produce sound. FIG. 1 shows a front, perspective view of a dental upper teeth and mouth molding tray 10 which is used to produce an upper teeth and mouth mold of a user. The upper teeth 11 of a user are shown positioned above the molding tray 10. The molding tray 10 has an upper teeth forming portion 12, an upper mouth sides forming portion 13, and an upper mouth roof forming portion 14. The molding tray 10 has a front end 15, a rear end 16, a left side 17, and a right side 18. Commercially available polysilicon teeth impression material, for example, is placed in the molding tray 10 and a solid plastic impression (not shown) of the upper teeth and mouth of a user is made by methods well known in the art.

FIG. 2 shows a rear perspective view of an upper teeth and upper mouth mold 20 of a user. The upper mouth mold 20 is made from the solid plastic impression which is made with the molding tray 10, by methods well known in the art. The upper mouth mold 20 has sides 21 of the upper mouth, a roof 22 of the upper mouth, a front end 23, a rear end 24, a right side 25, a left side 26, and an interior 27. The upper mouth mold 20 replicates the user's teeth 28, the interior sides 21 of the mouth, and the roof 22 of the mouth. A mouthpiece can be made of any suitable plastic or rubber using the upper mouth mold 20 by methods well known in the art. The mouthpiece of the present invention will cover and hold the sides and tops 29 of the teeth 28.

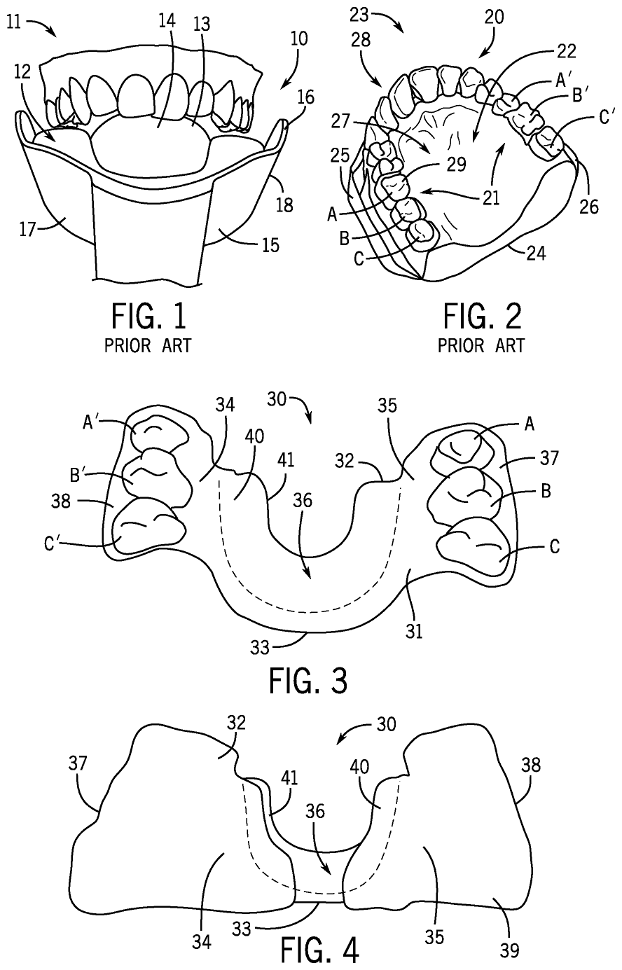

FIG. 3 is a top view of a mouthpiece 30 for an intraoral game caller. The mouthpiece 30 can be formed using the upper mouth mold 20. The mouthpiece 30 has a front end 32, rear end 33, a right side portion 34, a left side portion 35, a roof portion 36, a right side teeth portion 37, a left side teeth portion 38, a topside 31, and a bottom side 39 (see FIG. 4). A retaining slot 40 is formed in the roof portion 36. The retaining slot 40 has an opening 41 for reversible insertion of an intraoral game caller. The topside 31 of the mouthpiece 30 engages the roof 22 of the upper mouth, the sides 21 of the upper mouth, and the teeth 28 of the upper mouth of a user. The teeth A, B, and C of the upper mouth mold 20 fit into the teeth holding members A, B, and C of the mouthpiece 30. The teeth A′, B′, and C′ of the mold 20 fit into the teeth holding members A′, B′, and C′ of the mouthpiece 30. Although the right teeth portion 37 and the left teeth portion 38 each show three teeth holding members, there may be more or fewer teeth holding members as desired. Positioning the teeth of a user in the teeth holding members retains the mouthpiece 30 in the upper mouth of the user and prevents the mouthpiece 30 from moving during use. A mouthpiece constructed to fit the upper mouth this way is a custom-fit mouthpiece.

FIG. 4 is a bottom view of the mouthpiece 30. FIG. 4 further shows the bottom side 39 of the mouthpiece 30.

FIG. 5 is a top view of an intraoral game caller 50 showing a topside 59 of the intraoral game caller 50. The game caller 50 has a U-shaped holder 51 having a front end 52, a rear end 53, a right side 54 and a left side 55 which define an open area 56. A game caller reed or diaphragm 57 is reversibly positioned in the open area 56 of the reed holder 51.

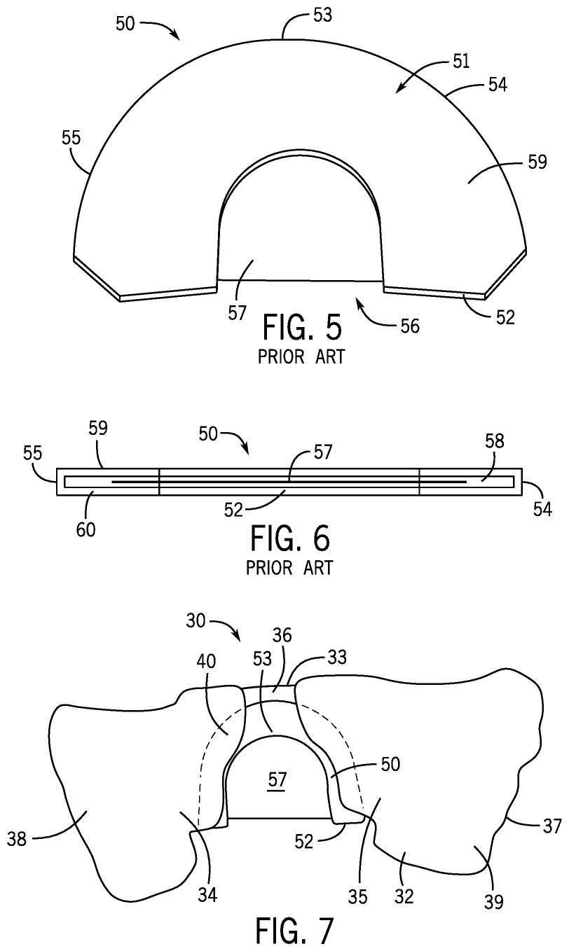

FIG. 6 is a front view of the intraoral game caller 50. FIG. 6 further shows a bottom side 60. The top side 59 and the bottom side 60 form an internal groove 58 into which the reed or diaphragm 57 is inserted.

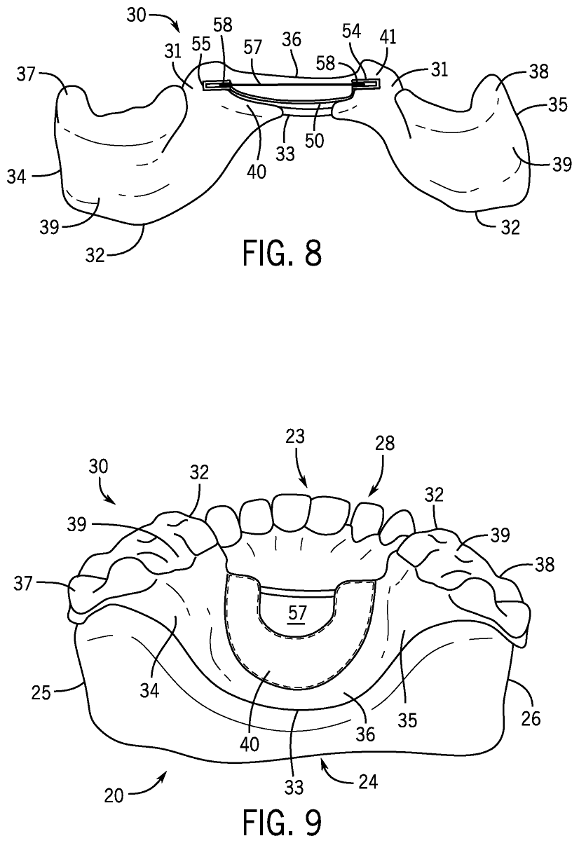

FIG. 7 is a bottom view of the mouthpiece 30 with an intraoral game caller 50 inserted into the retaining slot 40 of the mouthpiece 30. FIG. 8 is a front perspective view of the mouthpiece 30 with an intraoral game caller 50 inserted into the retaining slot 40 of the mouthpiece 30. FIG. 9 is a rear perspective view of the mouthpiece 30 with an intraoral game caller 50 inserted into the retaining slot 40 of the mouthpiece 30 and with the mouthpiece 30 positioned on the teeth and upper mouth of the upper mouth mold 20 of the user. The teeth holding members cover and hold the tops, the inner sides, and the outer sides of the teeth. The retaining slot 40 allows insertion and removal of a game caller 50 during use when the mouthpiece 30 is positioned in the upper mouth of the user.

In use, the teeth portion 37 and 38 of the mouthpiece 30 are placed over the upper teeth of a user. The roof portion 36 and the side portions 34 and 35 are pushed upward and remain against the roof and sides of the user's mouth. The roof portion 36 and the side portions 34 and 35 contact, cover, and seal a portion of the roof of the user's mouth so that air exhaled from the lungs of the user passes across only the bottom side 52 of the game caller 50 and out the mouth of the user. In addition, the mouthpiece 30 is constructed so that the teeth portions 37 and 38 of the mouthpiece 30 anchor the roof portion 36 against the roof of the mouth of the user. The tongue of the user is not required to push the roof portion 36 against the roof of the mouth. This feature of the mouthpiece 30 eliminates the need for a user to practice, train, and experiment to keep the caller 50 against the roof of the user's mouth as the user exhales to create a bird call.

The foregoing description illustrates and describes the disclosure. Additionally, the disclosure shows and describes only the preferred embodiments but, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. For example, the mouthpiece can be constructed so that the retaining slot and game caller are positioned at the front, middle, or rear of the roof of the mouth. The mouthpiece may be constructed to cover just one tooth, some of the teeth, or all the teeth of a user. The mouthpiece may be constructed to simulate a call for any type of bird, any type of mammal, or any type of predator, for example, a coyote. Any suitable type of plastic or rubber may be used to form the mouthpiece. Any type of reed or diaphragm may be used with the mouthpiece. The mouthpiece can be made from a 3D dental scan instead of a dental mold. The teeth portions of the mouthpiece can be formed by heating the mouthpiece, placing the mouthpiece in the upper mouth over the upper teeth, and biting down on the mouthpiece by methods known in the art.

The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above in order to explain the nature of this invention may be made by those skilled in the art without departing from the principle and scope of the invention as recited in the following claims

1. A mouthpiece for an intraoral game caller, the mouthpiece comprising:
a) one or more teeth holding members constructed to cover and hold one or more teeth of a user;
b) side portions extending from the teeth holding members;
c) a roof portion extending from the side portions;
d) a retaining slot in the roof portion for reversible insertion and removal of an intraoral game caller; and
e) the mouthpiece is made entirely of plastic or rubber and the mouthpiece is flexible.

2. The mouthpiece of claim 1, wherein the teeth holding members are constructed to cover and hold tops and sides of the one or more teeth.

3. The mouthpiece of claim 1, wherein the mouthpiece is a custom fit mouthpiece.

4. The mouthpiece of claim 1, wherein the one or more teeth holding members anchor the roof portion against the roof of the mouth of the user so that the roof portion contacts, covers, and seals a portion of the roof of the user's mouth.

5. The mouthpiece of claim 1, wherein the retaining slot is constructed to allow insertion of an intraoral game caller into and removal of an intraoral game caller from the retaining slot during use when the mouthpiece and retaining slot are positioned in the upper mouth of the user.

6. The mouthpiece of claim 1, wherein the roof portion and retaining slot are constructed to be restricted to the front, middle, or rear area of the roof of the upper mouth of the user.

7. A mouthpiece for an intraoral game caller, the mouthpiece comprising:
a) one or more teeth holding members constructed to cover and hold one or more teeth of a user, wherein the teeth holding members are constructed to cover and hold tops and sides of the one or more teeth;
b) side portions extending from the teeth holding members;
c) a roof portion extending from the side portions;
d) a retaining slot in the roof portion for reversible insertion and removal of an intraoral game caller; and
e) the mouthpiece is made entirely of plastic or rubber and the mouthpiece is flexible.

8. The mouthpiece of claim 7, wherein the mouthpiece is a custom fit mouthpiece.

9. The mouthpiece of claim 7, wherein the one or more teeth holding members anchor the roof portion against the roof of the mouth of the user so that the roof portion contacts, covers, and seals a portion of the roof of the user's mouth.

10. The mouthpiece of claim 7, wherein the retaining slot is constructed to allow insertion of an intraoral game caller into and removal of an intraoral game caller from the retaining slot during use when the mouthpiece and retaining slot are positioned in the upper mouth of the user.

11. The mouthpiece of claim 7, wherein the roof portion and retaining slot are constructed to be restricted to the front, middle, or rear area of the roof of the upper mouth of the user.

12. A mouthpiece for an intraoral game caller, the mouthpiece comprising:
a) one or more teeth holding members constructed to cover and hold one or more teeth of a user, wherein the teeth holding members are constructed to cover and hold tops and sides of the one or more teeth;
b) side portions extending from the teeth holding members;
c) a roof portion extending from the side portions;
d) a retaining slot in the roof portion for reversible insertion and removal of an intraoral game caller; and
e) the mouthpiece is made entirely of plastic or rubber and the mouthpiece is flexible, wherein the mouthpiece is a custom fit mouthpiece.

13. The mouthpiece of claim 12, wherein the one or more teeth holding members anchor the roof portion against the roof of the mouth of the user so that the roof portion contacts, covers, and seals a portion of the roof of the user's mouth.

14. The mouthpiece of claim 12, wherein the retaining slot is constructed to allow insertion of an intraoral game caller into and removal of an intraoral game caller from the retaining slot during use when the mouthpiece and retaining slot are positioned in the upper mouth of the user.

15. The mouthpiece of claim 12, wherein the roof portion and retaining slot are constructed to be restricted to the front, middle, or rear area of the roof of the upper mouth of the user.

16. A mouthpiece for an intraoral game caller, the mouthpiece comprising:
a) one or more teeth holding members constructed to cover and hold one or more teeth of a user, wherein the teeth holding members are constructed to cover and hold tops and sides of the one or more teeth;
b) side portions extending from the teeth portion;
c) a roof portion extending from the side portions, wherein the one or more teeth holding members anchor the roof portion against the roof of the mouth of the user so that the roof portion contacts, covers, and seals a portion of the roof of the user's mouth;
d) a retaining slot in the roof portion for reversible insertion and removal of an intraoral game caller, wherein the retaining slot is constructed to allow insertion of an intraoral game caller into and removal of an intraoral game caller from the retaining slot during use when the mouthpiece and retaining slot are positioned in the upper mouth of the user; and
e) the mouthpiece is made entirely of plastic or rubber and the mouthpiece is flexible, wherein the mouthpiece is a custom fit mouthpiece.

17. The mouthpiece of claim 16, wherein the roof portion and retaining slot are constructed to be restricted to the front, middle, or rear area of the roof of the upper mouth of the user.
